(19) United States
(12) Patent Application Publication
(10) Pub. No.: US 2020/0083789 A1
(43) Pub. Date: Mar. 12, 2020

(54) BRUSHLESS MOTOR

(71) Applicant: MITSUBA Corporation, Gunma (JP)

(72) Inventors: Ryo OHORI, Gunma (JP); Naoki SHIODA, Gunma (JP); Tomoyasu SUGIYAMA, Gunma (JP); Masaki HAYATA, Gunma (JP)

(21) Appl. No.: 16/610,949

(22) PCT Filed: May 1, 2018
(86) PCT No.: PCT/JP2018/017378

§ 371 Date: Nov. 5, 2019

(30) Foreign Application Priority Data
May 30, 2017 (JP) 2017-106335

(51) Int. Cl. H02K 29/08; H02K 11/215

(52) U.S. Cl. CPC H02K 29/08; H02K 11/215

(57) ABSTRACT

A brushless motor includes: a stator having a stator core and a winding; a rotor having a magnet; and a magnetic sensor for detecting the rotational position of the rotor. The rotor has a skew structure, and the magnet is skew-magnetized. The magnet has an overhang part. The magnetic sensor is disposed opposite to an axial end surface of the overhang part. The skew angle of the magnet is set in accordance with the angular deviation of sensor arrangement corresponding to motor specifications such as Δ-connection or sine wave drive in a state where the magnetic sensor is disposed at an optimum position less affected by a winding field.

### TECHNICAL FIELD

The present invention relates to a brushless motor and, more particularly, to a so-called direct sensing type brushless motor that directly senses magnetic flux from a rotor magnet without using a sensor magnet.

### BACKGROUND ART

There is conventionally known a drive system that detects the position of a rotor by directly sensing magnetic flux from a rotor magnet without using a sensor magnet in drive control of a brushless motor (for example, Patent Document 1). Such a drive system is called “direct sensing”. There is no need for a motor adopting the direct sensing system to be provided with a sensor magnet therein and, therefore, the number of required components can be reduced, which in turn leads to device miniaturization and cost reduction. However, the direct sensing type motor has a disadvantage that sensing of a rotor position is apt to be disturbed due to the influence of magnetic flux from a winding field. Thus, in conventional direct sensing type motors, in order to minimize the influence of a winding field, a sensor is generally disposed to detect switching of magnetic poles at a position farthest from the winding of an energized phase, as illustrated in FIG. 5A.

A brushless motor 51 illustrated in FIG. 5A has a two-pole rotor 52 and six respective-phase windings 53 (53Ua, 53Ub, 53Va, 53Vb, 53Wa and 53Wb). Three magnetic sensors 54 (54U, 54V, and 54W) for detecting switching of magnetic poles of the rotor 52 are provided corresponding to three phases. Each magnetic sensor 54 is disposed to detect switching of magnetic poles at a position farthest from the winding 53 of a currently energized phase. FIG. 5B is a timing chart illustrating the relationship between a magnetic detection timing of the magnetic sensors 54 and energization timing of the windings 53. As can be seen from FIGS. 5A and 5B, when, for example, the U-phase windings 53Ua and 53Ub are energized, switching of magnetic poles of the rotor 52 is detected by the magnetic sensor 54W disposed at a position farthest from the the U-phase windings 53Ua and 53Ub.

### CITATION LIST

### Patent Document

Patent Document 1: JP 2016-19362 A

Patent Document 2: JP 2016-178751 A

### DISCLOSURE OF THE INVENTION

### Problems to be Solved by the Invention

However, in the direct sensing type motor, the sensor arrangement as illustrated in FIG. 5A is ideal for Y-connection/square wave drive, because the position of the sensor allows the influence of a field to be minimized. In contrast, in a Δ-connection or sine wave drive, the sensor arrangement is deviated from the ideal position by an electric angle of 30°. Thus, when the sensor is disposed in accordance with the connection state or drive system, it is difficult to dispose the sensor at a desired position so as to suppress the influence of field magnetic flux. That is, for reasons of motor design, the sensor cannot be disposed at an ideal position less likely to be affected by a winding field.

### Means for Solving the Problems

A brushless motor according to the present invention includes: a stator having a stator core and a winding wound around the stator core; a rotor disposed radially inside the stator and having a magnet; and a magnetic sensor that detects magnetism of the magnet to detect a rotational position of the rotor. The rotor has a skew structure in which the switching position of magnetic poles of the magnet is deviated in the rotation direction thereof along the axial direction thereof. The magnet has an overhang part that axially protrudes from an axial end portion of the stator core without facing the stator core. The magnetic sensor is disposed so as to face the axial end surface of the overhang part of the magnet.

In the present invention, the magnetic sensor is disposed so as to face the axial end surface of the overhang part of the magnet to make the magnetic sensor away from the winding in the axial direction, thereby minimizing the influence of a winding field on the magnetic sensor. Further, a rotor having a skew structure is used to thereby reduce cogging torque, and a skew angle is set in accordance with angular deviation in sensor arrangement corresponding to motor specifications. With this arrangement, the magnetic sensor disposed at an optimum position where the influence of a winding field is small is adapted to the motor specifications (Δ-connection or sine wave drive). To achieve the skew structure of the rotor, a magnet that has been subjected to skew-magnetization may be used, or a step-skew structure using a segment magnet may be used.

In the brushless motor, the winding may have a densely wound part axially formed from the axial end portion of the stator core, and the overhang part may axially extend beyond the densely wound part and may be disposed closer to the magnetic sensor than the densely wound part.

In the brushless motor, the magnetic sensor may be disposed so as to be axially spaced from the magnet, and at least a part of the magnetic sensor may overlap the axial end surface of the overhang part.

Further, assuming that, of the magnetic pole switching position at opposite end portions of the magnet, a position on the overhang part side is P, and a position on the side opposite to the overhang part is Q, a skew angle θR between the P and Q representing a skew angle of the entire magnet including the overhang part is expressed by θR=θT+(θT/L)×OH, where L is an axial dimension of the stator core, θT is a skew angle of the magnet corresponding to the axial dimension of the stator core, and OH is an axial dimension of the overhang part. Further, assuming that a skew angle from the magnetic pole switching position Q to a center position M of the magnetic pole of of the magnet is θM, the θM is expressed by θM=θT/2. At this time, a skew angle θX=θR−θM from the magnetic pole center position M to the magnetic pole switching position P may be set according to motor specifications. In this case, the skew angle θX may be set in a range of 0°<θ≤60° (electric angle).

### Advantageous Effects of the Invention

According to the brushless motor of the present invention, the magnetic sensor is disposed so as to face the axial end surface of the overhang part of the magnet to thereby make the magnetic sensor away from the winding in the axial direction, making it possible to reduce the influence of a winding field on the magnetic sensor. Further, the rotor has a skew structure in which a switching position of magnetic poles of the magnet is deviated in the rotation direction along the axial direction, so that cogging torque can be reduced, and the skew angle of the magnet can be set in accordance with angular deviation of sensor arrangement corresponding to motor specifications. Thus, the magnetic sensor disposed at an optimum position can conform to the motor specifications. Hence, even when the magnetic sensor cannot be disposed at an optimum position in the rotation direction for design reasons, it is possible to dispose the magnetic sensor at an optimum position by adjusting the skew angle.

### BRIEF DESCRIPTION OF THE DRAWINGS

FIG. 1 is an explanatory view illustrating the configuration of a brushless motor which is an embodiment of the present invention;

FIGS. 2A and 2B are explanatory views illustrating the relationship between overhang amount and magnetic flux detection angle delay due to the influence of a winding field;

FIG. 3 is an explanatory view illustrating the positional relationship between a magnetic sensor and a magnet;

FIG. 4 is an explanatory view illustrating the arrangement of magnetic sensors; and

FIGS. 5A and 5B are explanatory view each illustrating a conventional sensor arrangement in a direct sensing type brushless motor.

### BEST MODE FOR CARRYING OUT THE INVENTION

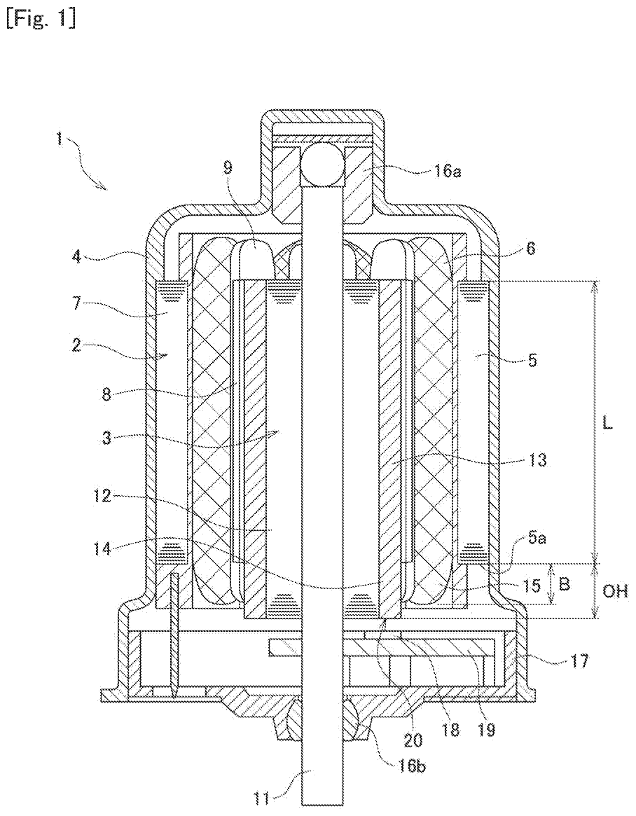

An embodiment of the present invention will be described in detail below with reference to the drawings. The object of the embodiment described below is to provide a brushless motor in which a magnetic sensor can be disposed at a position less likely to be affected by magnetic flux of a winding field, irrespective of motor design specifications. FIG. 1 is an explanatory view illustrating the configuration of a brushless motor 1 (hereinafter, abbreviated as “motor 1”) which is an embodiment of the present invention. The motor 1 is used as a power source for an automobile sunroof device and is configured as an inner-rotor type brushless motor in which a stator 2 and a rotor 3 are disposed outside and inside, respectively. The motor 1 adopts a direct sensing system that detects the position of a rotor by directly sensing magnetic flux from a rotor magnet.

The stator 2 has a housing 4, a stator core 5 fixed to the inner peripheral side of the housing 4, and three-phase (U, V, W) windings (coils) 6 wound around the stator core 5. The stator core 5 has a configuration obtained by laminating many steel sheets and has a ring-shaped yoke part 7 and a plurality of tooth parts 8 protruding inward from the yoke part 7. The winding 6 is wound around each tooth part 8 through an insulator 9.

The rotor 3 is disposed inside the stator 2. The rotor 3 has a configuration in which a rotary shaft 11, a rotor core 12, and a magnet 13 are arranged coaxially. The cylindrical rotor core 12 has a configuration obtained by laminating many steel sheets and is mounted to the outer periphery of the rotary shaft 11. The magnet 13 is fixed to the outer periphery of the rotor core 12. The rotor 3 has a skew structure in which the magnetic pole switching position of the magnet 13 is deviated in the rotation direction along the axial direction. The magnet 13 is skew-magnetized such that the magnetic pole switching position is axially inclined with respect to the center axis. Adopting such a skew structure allows reduction in cogging torque in the motor 1.

In the motor 1, the magnet 13 axially protrudes, at its one end side, from an axial end portion 5a of the stator core 5. That is, at the one end side of the magnet 13, an overhang part 14 is formed so as to protrude from the axial end portion 5a of the stator core 5 without facing the stator core 5. The overhang part 14 extends beyond a densely wound part 15 formed at the axial end portion of the winding 6. An axial length (overhang amount) OH of the overhang part 14 is larger than an axial dimension B of the densely wound part 15 (OH>B).

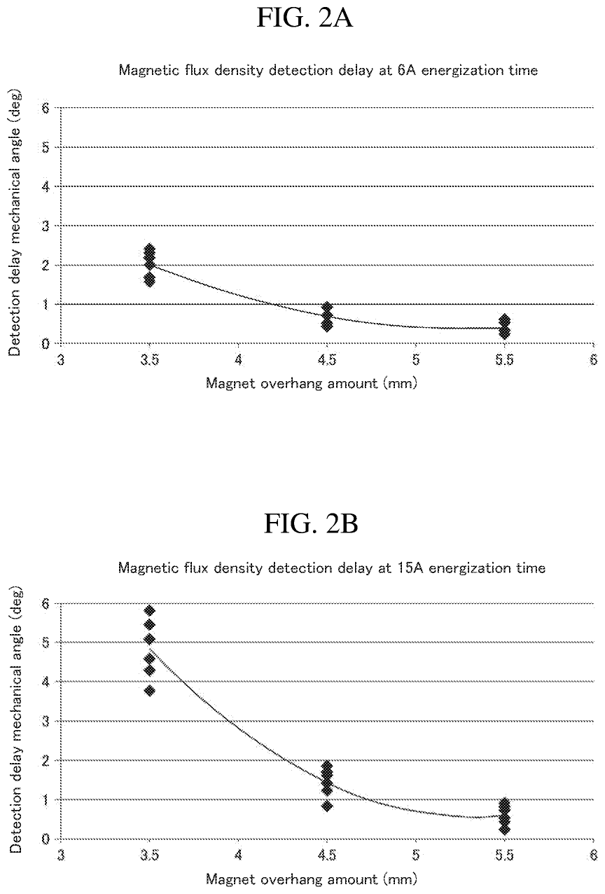

In the brushless motor that performs direct sensing, a difference in magnetic pole switching detection position is caused between energization time and non-energization time due to the influence of a winding field, and the detection angle tends to be delayed in energization time as compared to non-energization time. FIGS. 2A and 2B are explanatory views illustrating the relationship between the overhang amount OH and the magnetic flux detection angle delay (delay in detection of magnetic pole switching) due to the influence of a winding field. FIG. 2A illustrates 6A energization time, and FIG. 2B illustrates 15A energization time. Analysis made by the present inventors reveals that the larger the overhang amount OH is, the smaller the detection angle delay and that as the overhang amount OH is smaller than the dimension B of the densely wound part 15, the amount of increase in the delay becomes larger. Thus, in the motor 1, the length the overhang part 14 is set larger than the dimension of the densely wound part 15 (OH>B) to thereby minimize the influence of a winding field.

Opposite end portions of the housing 4 are attached with bearings 16a and 16b, respectively. The rotary shaft 11 is rotatably supported by the bearings 16a and 16b. The housing 4 is formed into a bottomed cylindrical shape, and a sensor bracket 17 is attached to the opening side end portion of the housing 4. The sensor bracket 17 is attached with a substrate 19 having a magnetic sensor 18 using a hall element or the like. The magnetic sensor 18 is a so-called surface-mount type sensor and detects the rotational position of the rotor 3 by detecting the magnetism of the magnet 13.

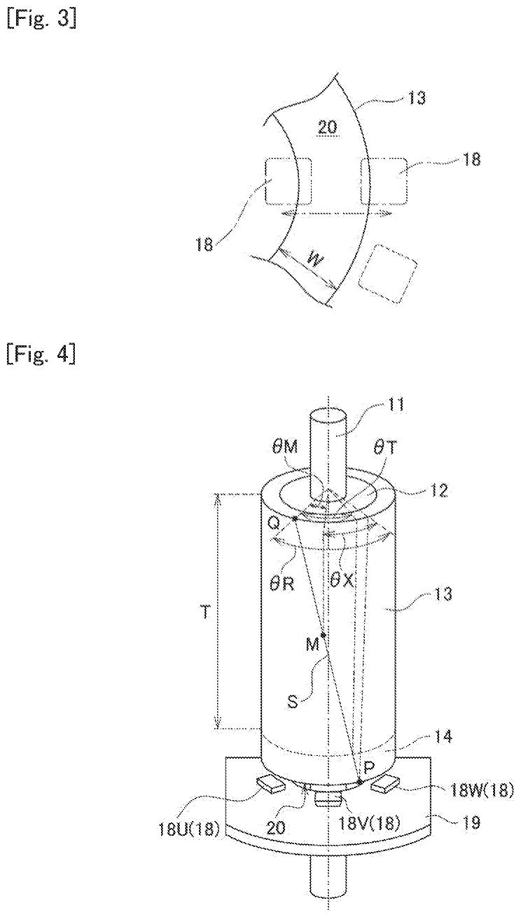

The magnetic sensor 18 is disposed so as to directly face an axial end surface 20 (axial end surface of the overhang part 14) of the magnet 13. In other words, the magnetic sensor 18 is disposed vertically just below the axial end surface 20. In this case, the magnetic sensor 18 need not face the entire axial end surface 20. FIG. 3 is an explanatory view illustrating the positional relationship between the magnetic sensor 18 and the magnet 13. As denoted by a dashed-and-dotted line in FIG. 3, it is sufficient that a part of the magnetic sensor 18 is disposed so as to overlap the axial end surface 20 of the magnet 13. That is, the magnetic sensor 18 is disposed at such a position that at least a part thereof overlaps the range of a radial width W of the axial end surface 20. A state (dashed line in FIG. 3) where the magnetic sensor 18 and the magnet 13 do not overlap each other at all is not preferable because there is a possibility that magnetic flux from the magnet 13 cannot properly be captured.

In order to detect commutation timing of respective phases, three magnetic sensors 18 (18U, 18V, 18W) are provided for the U-, V- and W- phases. FIG. 4 is an explanatory view illustrating the arrangement of the magnetic sensors 18. As illustrated in FIG. 4, in the motor 1, three magnetic sensors 18 (18U, 18V, 18W) are arranged in the circumferential direction.

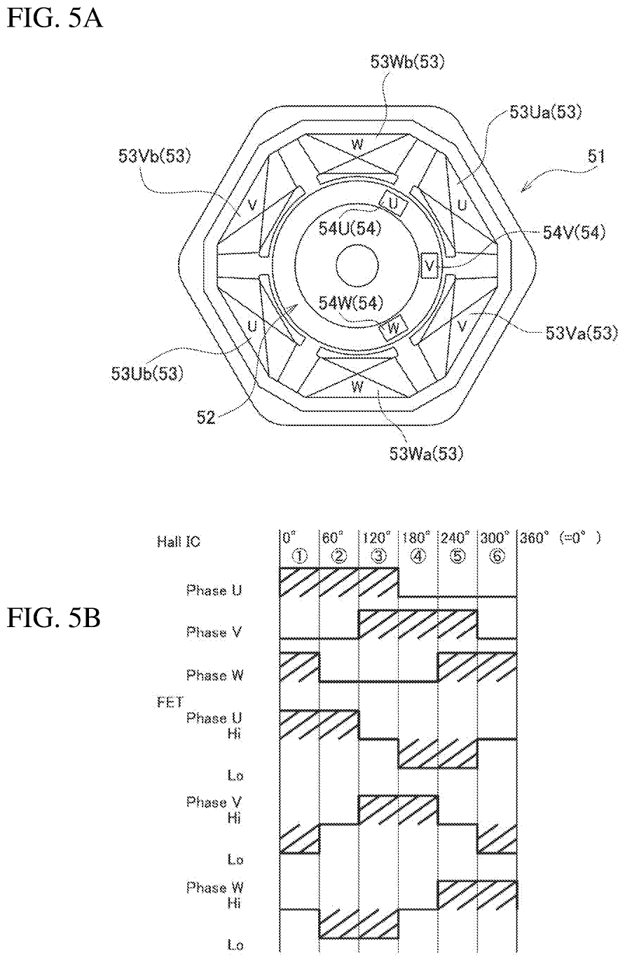

Each magnetic sensor 18 is disposed at the ideal position like that illustrated in FIG. 5 and detects switching of magnetic poles at a position farthest from the winding 6 of the currently energized phase. The magnet 13 is skew-magnetized and, in the motor 1, even when the sensor arrangement is deviated from the ideal position by an electrical angle of 30° as in the case of a Δ-connection or sine wave drive, direct sensing can be achieved while keeping an optimum sensor arrangement by adjustment of a skew angle.

In the motor 1, the skew angle is set as follows. As illustrated in FIG. 4, in the motor 1, a magnetic pole switching position S is axially inclined by the skew magnetization. Of the magnetic pole switching position S at opposite end portions of the magnet 13, a position on the overhang part 14 side (one end side) is assumed to be P, and a position on the side (other end side) opposite to the overhang part 14 is assumed to be Q. In this case, a skew angle θR of the entire magnet 13 including the overhang part 14 corresponds to the skew angle between the points P and Q.

In this case, assuming that a skew angle corresponding to an axial dimension (stator lamination thickness) L of the stator core 5 is θT and that the overhang amount is OH, the skew angle θR (skew angle between the points P and Q) of the motor 1 is expressed by:

θR=θT+(θT/L)×OH.

On the other hand, a skew angle θM at a magnetic pole center position M of the magnet 13 is expressed by:

θM=θT/2.

Thus, in the motor 1, a skew angle θX (=θR−θM) from the magnetic pole center position M to the point P (a part of the magnetic pole switching position S that faces the magnetic sensor 18 at the axial end surface 20) is set in accordance with the deviation of the sensor arrangement corresponding to motor specifications (Δ-connection or sine wave drive).

For example, when the sensor arrangement is deviated by an electric angle of 30° (in the motor 1, mechanical angle of) 15° from the ideal position due to Δ-connection, the value of the above “θX=(θR−θM)” is set to the electric angle of 30°. As a result, the magnetic pole switching timing detected by the magnetic sensor 18 is adjusted by the electric angle of 30°, making it possible for the sensor 18 to be adapted to a motor of Δ-connection in a state where the magnetic sensor 18 is disposed (fixed) at an optimum position. That is, by further adjusting the angle of the skew having cogging torque reduction effect, it is possible to perform drive control of a brushless motor of Δ-connection with the magnetic sensor 18 disposed at an optimum position where the influence of magnetic flux of a winding field can be minimized. The skew angle adjustment may be performed in a range of an electric angle of at least 30° (electric angle of 60°, in total) to the left and right from a zero skew state according to the motor rotation direction.

As described above, in the motor 1 according to the present invention, a surface-mount type sensor is used as the magnetic sensor 18, and the sensor 18 is disposed so as to face the axial end surface 20 of the magnet 13. Then, the length of the overhang part 14 is set larger than the dimension of the densely wound part 15 (OH>B) to make the magnetic sensor 18 away from the winding 6, thereby reducing the influence of a winding field. That is, the overhang part 14 reduces the influence of a winding field in the axial direction of the motor 1.

Further, the magnet 13 is skew-magnetized, and the skew angle of the magnet 13 is set in accordance with the angular deviation of sensor arrangement corresponding to motor specifications, and the magnetic sensor 18 is made to conform to motor specifications in a state where it is disposed at an optimum position. Thus, even when the magnetic sensor 18 cannot be disposed at an optimum position in the rotation direction for design reasons, it is possible to dispose the magnetic sensor 18 at an optimum position by adjusting the skew angle. That is, the influence of a winding field can be minimized in the rotation direction of the motor 1 by the skew angle adjustment. Then, by dealing with field magnetic flux in the axial and rotation directions, it is possible to minimize the influence of a winding field to thereby improve control accuracy in the direct sensing type brushless motor.

The present invention is not limited to the above-described embodiment but may be variously modified without departing from the spirit and scope of the invention.

For example, although the present invention is applied to a motor having a so-called SPM structure wherein a magnet is provided at the outer periphery of a rotor in the above embodiment, the type of the motor to which the present invention is applicable is not limited to this. For example, the present invention can also be applied to a motor having an IPM structure wherein a magnet is embedded in a rotor. Further, the skew inclination direction and skew inclination angle can be set appropriately according to motor specifications.

Further, as the skew structure of the rotor 3, a step-skew structure in which the magnetic pole switching position is deviated stepwise in the rotation direction along the axial direction can be adopted. In this case, in the step skew using a segment magnet, a plurality of rows of segment magnets are disposed at the outer periphery of the rotor along the axial direction. Further, in each row, a plurality of segment magnets are disposed along the rotation direction (peripheral direction), and the magnetic pole switching position is deviated in the rotation direction along the axial direction between the axially adjacent magnet rows. In a motor having such a step skew structure, the skew angle θR and the like in the present invention are calculated with a line axially connecting the centers of the respective segment magnets handled as “magnetic pole switching position S”, and the above-described skew angle adjustment is performed.

### INDUSTRIAL APPLICABILITY

The brushless motor according to the present invention is applicable not only to a sunroof motor, but also to various on-vehicle motors such as a power window motor and power seat motor and motors used in home electric appliances such as air-conditioner.

### REFERENCE SIGNS LIST

1: Brushless motor

2: Stator

3: Rotor

4: Housing

5: Stator core

5a: Axial end portion

6: Winding

7: Yoke part

8: Tooth part

9: Insulator

11: Rotary shaft

12: Rotor core

13: Magnet

14: Overhang part

15: Densely wound part

16a, 16b: Bearing

17: Sensor bracket

18: Magnetic sensor

19: Substrate

20: Axial end surface

51: Brushless motor

52: Rotor

53: Winding

53Ua, 53Ub, 53Va, 53Vb, 53Wa, 53Wb: Each-phase winding

54: Magnetic sensor

54U, 54V, 54W: Magnetic sensor

B: Axial dimension of densely wound part

OH: Overhang amount

S: Magnetic pole switching position

W: Magnet width

P: Magnetic pole switching position on one end side

Q: Magnetic pole switching position on the other end side

M: Magnetic pole center position

L: Axial dimension of stator core (stator lamination thickness)

θT: Skew angle corresponding to stator lamination thickness

θM: Skew angle at magnetic pole center position M

θR: Skew angle of entire magnet

θX: Skew angle from magnetic pole center position M to point P

1-6. (canceled)

7. A brushless motor characterized by comprising:
a stator having a stator core and three-phase windings wound around the stator core;
a rotor disposed radially inside the stator and having a magnet; and
a magnetic sensor that detects magnetism of the magnet to detect a rotational position of the rotor, wherein
the rotor has a skew structure in which the switching position of magnetic poles of the magnet is deviated in the rotation direction thereof along the axial direction thereof,
the magnet has an overhang part that axially protrudes from an axial end portion of the stator core without facing the stator core, and
the magnetic sensor is disposed so as to face an axial end surface of the overhang part of the magnet and to detect switching of magnetic poles of the magnet at a position farthest from the winding of a currently energized phase.

8. The brushless motor according to claim 7, wherein
the winding has a densely wound part axially formed from an axial end portion of the stator core, and
the overhang part axially extends beyond the densely wound part and disposed closer to the magnetic sensor than the densely wound part.

9. The brushless motor according to claim 7, wherein
the magnetic sensor is disposed so as to be axially spaced from the magnet, and at least a part of the magnetic sensor overlaps the opposed axial end surface of the overhang part.

10. The brushless motor according to claim 8, wherein
the magnetic sensor is disposed so as to be axially spaced from the magnet, and at least a part of the magnetic sensor overlaps the opposed axial end surface of the overhang part.

11. The brushless motor according to claim 7, wherein
assuming that, of the magnetic pole switching position at opposite end portions of the magnet, a position on the overhang part side is P, and a position on the side opposite to the overhang part is Q, a skew angle θR between the P and Q representing a skew angle of the entire magnet including the overhang part is expressed by:
θR=θT+(θT/L)×OH,
where L is an axial dimension of the stator core, θT is a skew angle of the magnet corresponding to the axial dimension of the stator core, and OH is an axial dimension of the overhang part,
assuming that a skew angle from the magnetic pole switching position Q to a center position M of the magnetic pole of the magnet is θM, the θM is expressed by:
θM=674 T/2,
and
a skew angle θX=θR−θM from the magnetic pole center position M to the magnetic pole switching position P is set according to motor specifications.

12. The brushless motor according to claim 8, wherein
assuming that, of the magnetic pole switching position at opposite end portions of the magnet, a position on the overhang part side is P, and a position on the side opposite to the overhang part is Q, a skew angle θR between the P and Q representing a skew angle of the entire magnet including the overhang part is expressed by:
θR=θT+(θT/L)×OH,
where L is an axial dimension of the stator core, θT is a skew angle of the magnet corresponding to the axial dimension of the stator core, and OH is an axial dimension of the overhang part,
assuming that a skew angle from the magnetic pole switching position Q to a center position M of the magnetic pole of the magnet is θM, the θM is expressed by:
θM=θT/2,
and
a skew angle θX=θR−θM from the magnetic pole center position M to the magnetic pole switching position P is set according to motor specifications.

13. The brushless motor according to claim 9, wherein
assuming that, of the magnetic pole switching position at opposite end portions of the magnet, a position on the overhang part side is P, and a position on the side opposite to the overhang part is Q, a skew angle θR between the P and Q representing a skew angle of the entire magnet including the overhang part is expressed by:
θR=6θT+(θT/L)×OH,
where L is an axial dimension of the stator core, θT is a skew angle of the magnet corresponding to the axial dimension of the stator core, and OH is an axial dimension of the overhang part, assuming that a skew angle from the magnetic pole switching position Q to a center position M of the magnetic pole of the magnet is θM, the θM is expressed by:
θM=θT/2,
and
a skew angle θX=θR−θM from the magnetic pole center position M to the magnetic pole switching position P is set according to motor specifications.

14. The brushless motor according to claim 10, wherein
assuming that, of the magnetic pole switching position at opposite end portions of the magnet, a position on the overhang part side is P, and a position on the side opposite to the overhang part is Q, a skew angle θR between the P and Q representing a skew angle of the entire magnet including the overhang part is expressed by:
θR=θT+(θT/L)×OH,
where L is an axial dimension of the stator core, θT is a skew angle of the magnet corresponding to the axial dimension of the stator core, and OH is an axial dimension of the overhang part, assuming that a skew angle from the magnetic pole switching position Q to a center position M of the magnetic pole of the magnet is θM, the θM is expressed by:
θM=θT/2,
and
a skew angle θX=θR−θM from the magnetic pole center position M to the magnetic pole switching position P is set according to motor specifications.

15. The brushless motor according to claim 11, wherein the skew angle θX is set in a range of 0°<θX≤60° (electric angle).

16. The brushless motor according to claim 12, wherein the skew angle θX is set in a range of 0°<θX≤60° (electric angle).

17. The brushless motor according to claim 13, wherein the skew angle OX is set in a range of 0°<θX≤60° (electric angle).

18. The brushless motor according to claim 14, wherein the skew angle OX is set in a range of 0°<θX≤60° (electric angle).
